(19) United States
(12) Patent Application Publication
(10) Pub. No.: US 2025/0014070 A1
(43) Pub. Date: Jan. 9, 2025

(54) INTELLIGENT SYSTEMS AND METHODS FOR CLICK PRICE GENERATION

(71) Applicant: Allstate Insurance Company, Northbrook, IL (US)

(72) Inventor: Rex Winn, Northbrook, IL (US)

(73) Assignee: Allstate Insurance Company, Northbrook, IL (US)

(21) Appl. No.: 18/764,596

(22) Filed: Jul. 5, 2024

Related U.S. Application Data
(60) Provisional application No. 63/512,427, filed on Jul. 7, 2023.

(51) Int. Cl. G06Q 30/0242

(52) U.S. Cl. CPC G06Q 30/0242

(57) ABSTRACT

Systems and methods for intelligent click price generation may include solving for a plurality of coefficients of a plurality of respective factors, wherein each coefficient is an exponent in an equation; determining a factor value for each factor, wherein the factor value for each factor is between 0 and 1; setting a respective factor exponent for each factor value for each factor to 0 or 1 based on a truth determination of a factor whether to include each factor; solving for a plurality of respective factor solutions based on each factor value for each factor set to a power of each respective factor exponent; determining a probability of a conversion associated with an imminent click for an individual i based on a multiplication of the plurality of respective factor solutions; and generating a click price based on at least the probability and a target acquisition cost of an entity.

### CROSS-REFERENCE TO RELATED APPLICATIONS

The present application claims priority to U.S. Provisional Application No. 63/512,427, filed Jul. 7, 2023, and entitled “AUTOMATED ADVERTISING PRICING SYSTEMS AND METHODS,” the entirety of which is incorporated herein.

### TECHNICAL FIELD

The present disclosure relates to systems and methods for intelligent systems and methods and, in particular, artificial intelligence (AI) based systems and methods for predicting a probability of a conversion associated with an imminent click and generating a click price based at least thereon.

### BACKGROUND

Publishers can price clicks associated with clicks on advertisements via search platforms, social platforms, or the like for an advertiser and attempt to price a click at a highest end of the advertiser's performance constraint. However, consequences of overpricing clicks may result in the advertiser's withdrawal due to excessing costs. Accordingly, a need exists for efficient method of accurately pricing advertisement clicks by a publisher for an advertiser.

### BRIEF SUMMARY

According to the subject matter of the present disclosure, a system may include a processor; and a memory storing computer-executable instructions that, when executed by the processor, cause the system to: solve for a plurality of coefficients of a plurality of respective factors, wherein each coefficient is an exponent in an equation, and determine a factor value for each factor, wherein the factor value for each factor is between 0 and 1. The computer-executable instructions, when executed by the processor, may further cause the system to: set a respective factor exponent for each factor value for each factor to 0 or 1 based on a truth determination of a factor whether to include each factor, wherein the respective factor exponent set to 0 is indicative of the truth determination of the factor being false, solve for a plurality of respective factor solutions based on each factor value for each factor set to a power of each respective factor exponent, determine a probability of a conversion associated with an imminent click for an individual i based on a multiplication of the plurality of respective factor solutions, and generate a click price based on at least the probability of the conversion associated with the imminent click for the individual i and a target acquisition cost of an entity.

According to another embodiment of the present disclosure, a system may include a processor; and a memory storing computer-executable instructions that, when executed by the processor, cause the system to: solve for a plurality of coefficients of a plurality of respective factors, wherein each coefficient is an exponent in an equation, determine a factor value for each factor, wherein the factor value for each factor is between 0 and 1, and set a respective factor exponent for each factor value for each factor to 0 or 1 based on a truth determination of a factor whether to include each factor, wherein the respective factor exponent set to 0 is indicative of the truth determination of the factor being false. The computer-executable instructions, when executed by the processor, may further cause the system to: solve for a plurality of respective factor solutions based on each factor value for each factor set to a power of each respective factor exponent, determine a probability of a conversion associated with an imminent click for an individual i based on a multiplication of the plurality of respective factor solutions, and generate a click price based on at least the probability of the conversion associated with the imminent click for the individual i and a target acquisition cost of an advertiser, wherein the target acquisition cost is a predetermined value provided by the advertiser and is indicative of desired spend for a product associated with the click price. The plurality of factors may include a homeowner status, an insured status, a credit status, or any combination thereof.

According to yet another embodiment of the present disclosure, a method may include solving, by a processor, for a plurality of coefficients of a plurality of respective factors, wherein each coefficient is an exponent in an equation, and determining, by the processor, a factor value for each factor, wherein the factor value for each factor is between 0 and 1. The method may further include setting a respective factor exponent for each factor value for each factor to 0 or 1 based on a truth determination of a factor whether to include each factor, wherein the respective factor exponent set to 0 is indicative of the truth determination of the factor being false, solving, by the processor, for a plurality of respective factor solutions based on each factor value for each factor set to a power of each respective factor exponent, determining a probability of a conversion associated with an imminent click for an individual i based on a multiplication of the plurality of respective factor solutions, and generating, by the processor, a click price based on at least the probability of the conversion associated with the imminent click for the individual i and a target acquisition cost of an entity.

Although the concepts of the present disclosure are described herein with primary reference in at least FIGS. 1-3 to systems and methods for click price generation in an advertisement setting, it is contemplated that the concepts will enjoy applicability to any setting for purposes of machine learning model prediction and support for price setting generation, including and not limited to, other business or organizational or technical based settings.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates an environment for intelligent machine learning model prediction for click price generation, according to one or more embodiments shown and described herein;

FIG. 2 illustrates a flowchart process for the environment of FIG. 1, according to one or more embodiments shown and described herein; and

FIG. 3 illustrates a computer implemented system including a system for use with the process flow of FIG. 2 and the environment of FIG. 1, according to one or more embodiments shown and described herein.

### DETAILED DESCRIPTION

In embodiments described herein, systems and methods may include a software application that is configured to predict a probability of a conversion associated with an imminent click and generating a click priced based at least thereon. The software application may be implemented on and trained by an artificial intelligence (AI) based system that may include a machine learning model feature as described in greater detail below.

When publishers generate click prices to price advertisement clicks of an advertiser, the publishers may encounter problems such as small sample sizes in attempting to generate the click price while also facing issues with respect to overpricing or underpricing of a click for an advertisement of the advertiser. The systems and methods disclosed herein can allow for automatic generation of optimized click prices for advertisements of advertisers and dynamic changes of click prices in real-time, such as reducing click prices by 20% immediately by including a multiplication of a factor of 0.8 to an overall equal based on at least a multiplication of factors to determine click price, and can allow for inputs of heuristics to account for small sample sizes. As a non-liming example, heuristic data may be associated with data that is unable to be provided with training data validation sets and can change over time in a manner than can impact a trained model if not accounting for and can also allow for overwriting to the model to account for changes and/or a small sample size (e.g., applying penalty terms for outliers in the sample size as described in greater detail below for more accurate results using the data). An implementation of heuristics allow for rule-based algorithms and/or metrics as described herein to allow for a categorization or class interface or alternative decision with respect to data for a model. As a non-limiting example, a model can be trained around a set penalty associated with a type of factor, such as a 20% penalty on single car owners.

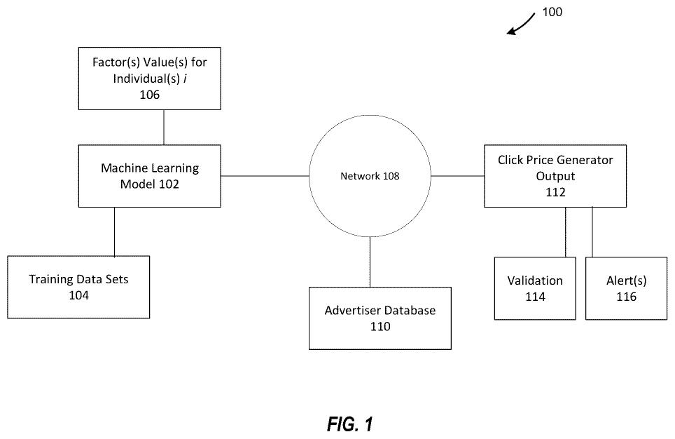

In embodiments, the systems and methods disclosed herein are configured to predict conversion rates (e.g., a probability of a conversion associated with an imminent click of an advertisement for an individual i) to price advertisement clicks for an advertiser by a publisher, utilizing a multiplier methodology to allow for implementation of heuristics (e.g., use of dynamic categorical data to overwrite a model output via manipulation of and/or provision of a factor) by multiplication of a plurality of factors determined as described herein to generate the probability, and minimize an amount of manual development needed by using automated and intelligent solutions to generate the click price based on at least the probability. Inputs including factor values for individuals and training data sets may be provided to a machine learning model that also may receive target acquisition costs of one or more entities, wherein an entity may be an advertiser. Such target acquisition costs may be received from an entity database, in which a conditional probability of a click by an individual based on a type of factor may be analyzed and various types of factors associated with the given individual are taken into account. In embodiments, a plurality of factors may include a homeowner status, an insured status, a credit status, or any combination thereof for an individual and values may be input into a matrix for the individual based on truth determinations as described in greater detail below. By way of example, and not as a limitation, an individual who owns a home may be assigned a truth determination of 1 for Yes, 0 for No, and 0 for Unknown and the associated values may be placed into a matrix. Automated outputs, including click price generation, validation, alerts, or combinations thereof, may be generated by an intelligent AI platform, such as within an environment 100 of FIG. 1 as described herein an in greater detail further below. The environment 100 may include a machine learning model 102 with the intelligent AI platform, as will be described in greater detail below.

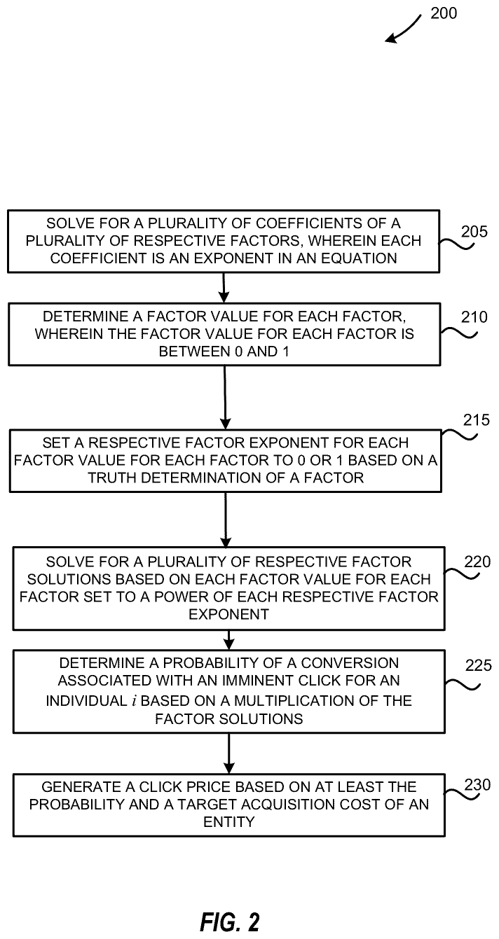

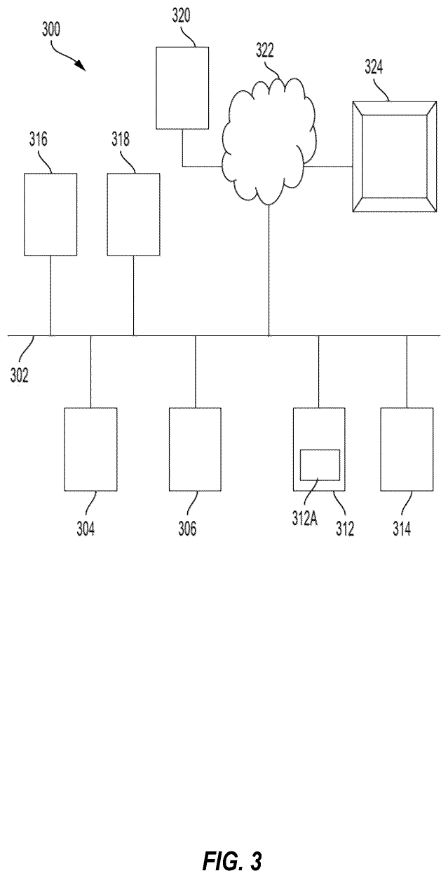

Referring to FIG. 1, the environment 100 for intelligent machine learning model prediction may include one or more machine learning models 102, one or more training data sets 104, one or more factor(s) value(s) for individual(s) i 106, a network 108, and an advertiser database 110. The environment 100 may include, as inputs the one or more training data sets 104 for a machine learning model 102, the factor(s) value(s) for individual(s) i 106, and data from the advertiser database 110. The environment 100 may further include one or more outputs, such as a click price generator output 112, a validation output 114, and one or more alerts 116 output by the intelligent AI platform communicatively coupled with the machine learning model 102 and the network 108. The machine learning model 102 may be an AI based software algorithm stored as machine readable instructions in a memory component 306 (FIG. 3) communicatively coupled to a processor 304 and configured to implement a control scheme (such as described below in a process 200 of FIG. 2) when executed by the processor 304.

Referring to FIG. 2, an embodiment of a process 200 is shown for use of the environment 100 of FIG. 1 (as implemented by a system 300 of FIG. 3, described in greater detail below). The process 200 may be used to predict a probability of a conversion associated with an imminent click (e.g., for an advertisement for an advertiser by a publisher) and generate a click price based at least thereon, as described in greater detail below.

In block 205, a plurality of coefficients (bₖ) of a plurality of respective factors may be solved for. Each coefficient may be an exponent in an equation. In block 210, a factor value for each factor may be determined. The factor value for each factor may be between 0 and 1, such that a multiplication of a plurality of factors may result in a probability value between 0 to 1 (e.g., associated with a probability between 0 to 100 percent). In embodiments, the factor value (Factorₖ) for each factor (k) may be based on a following factor value equation (EQUATION 1) below:

$${Factor}_{k} = \frac{{e}^{{b}_{k}}}{1 + {e}^{{b}_{k}}} \qquad ( EQUATION 1 )$$

In block 215, a respective factor exponent for each factor value for each factor may be set to 0 or 1 based on a truth determination of a factor. Without limitation, the plurality of factors may include a homeowner status, an insured status, a credit status, or any combination thereof. It is understood that the plurality of factors are not limited to these factor examples, and that other factors may be included without departing from the scope of the present disclosure. In aspects, for each factor value (Factorₖ) for each factor (k) of the plurality of factors: the respective factor exponent may be set to 0 or 1 based on a truth determination of the factor (k) of whether to include the factor (k). The respective factor exponent for the factor (k) set to 0 may be indicative of the truth determination of the factor (k) being false. In embodiments, respective factor exponent for the factor (k) set to 0 may be indicative of the truth determination of the factor (k) or unknown; and the respective factor exponent set to 1 may be indicative of the truth determination of the factor (k) being true. By way of example and without limitation, for a user determined to be a homeowner (e.g., true), the respective factor exponent may be set to 1 and indicative of a truth determination of this factor, that is the user being a homeowner, being true. By way of another example and without limitation, for a user determined not to being a homeowner (or whether it is unknown whether the user is a homeowner), the respective factor exponent may be set to 0 and indicative of a truth determination of this factor, that this the user being a homeowner, being false or unknown.

In aspects, a table of the plurality of factors may be generated. By way of example and without limitation, a request may be received to generate the table of the plurality of factors in a predetermined format. The request may be received by, for example, by a server 320 or a computing device 324 of system 300, as explained with reference to FIG. 3, which is communicatively coupled to the environment 100 of FIG. 1 to implement the process 200 of FIG. 2. It is understood that the request is not limited to these constituent components of system 300, and that the request to generate the table of the plurality of factors may be requested from other constituent components of system 300 and/or the environment 100. Moreover, a predetermined format of the plurality of factors in the table may include one or more columns, one or more rows, or any combination thereof. To generate the table, the respective status of the plurality of individuals i may correspond to a truth determination to store in the table for each factor, such as whether or not an individual i is, for example, a homeowner, insured, in a particular range of credit score, or any combination thereof. The respective status of the plurality of individuals i may correspond to a truth determination to determine whether to include a factor in an overall equation. For example, when a status of whether the individual i is, for example, a homeowner, insured, in a particular range of credit score, or any combination thereof, is false or unknown and not desired to be included in an equation, a truth determination of 0 may be set and correspond to a respective factor exponent as any factor value to an exponent of 0 will equal 1 and not impact an overall equation output. Thus, the table may be generated, in response to the request, in the predetermined format to ascertain the truth determination of at least one factor.

Continuing with the above example of the request to generate the table of the plurality of factors in the predetermined format, one or more of the plurality of factors may be selectively included or excluded in the table. For example, the request may include a prompt including an option to accept or decline any number of the plurality of the factors to be included for generation of the table of the plurality of factors in the predetermined format.

By way of another example and without limitation, the table of the plurality of factors may be automatically generated in the predetermined format over predetermined periods of time. In aspects, the predetermined format may include the respective status of a plurality of individuals i over a predetermined time period, including but not limited to over the last thirty days, sixty days, ninety days, or any other time period. It is understood that other time periods may be used and is therefore not limited to as such the disclosed time periods of thirty days, sixty days, or ninety days.

Continuing with the above example of automatically generating the table of the plurality of factors in the predetermined format over predetermined periods of time, one or more of the plurality of factors may be selectively included or excluded in the table. For example, the automatic generation of the table of the plurality of factors may include a prompt including an option to accept or decline any number of the plurality of the factors to be included for generation of the table of the plurality of factors in the predetermined format.

In block 220, a plurality of respective factor solutions may be solved for based on each factor value for each factor set to a power of each respective factor exponent. In aspects, a factor solution may be represented by, for example, EQUATION 2 below:

$$Factor Solution = {( \frac{{e}^{{b}_{k}}}{1 + {e}^{{b}_{k}}} )}^{{x}_{i k}} \qquad ( EQUATION 2 )$$

EQUATION 2 may be used to determine a factor (k) for a probability of conversion associated with an imminent click for an individual i using a respective factor exponent of xᵢₖ set to either 0 or 1 as described herein. For example, to the extent that a factor value of

$$( \frac{{e}^{{b}_{k}}}{1 + {e}^{{b}_{k}}} )$$

of EQUATION 1 is set to a power of 0 as the truth determination for the respective factor exponent of xᵢₖ, the respective factor solution yields a value of 1.

In block 225, a probability of a conversion associated with an imminent click for an individual i may be determined based on a multiplication of the factor solutions. As referred to herein, the imminent click may be defined as a click that has yet to occur but is given will occur as a condition of and to determine the probability (e.g., a probability of a given click). In aspects, the probability of the conversion associated with the imminent click for the individual i (Pᵢ) based on the multiplication of the plurality of respective factor solutions may be based on a following probability equation as EQUATION 3:

$${P}_{i} = {( \frac{{e}^{{b}_{0}}}{1 + {e}^{{b}_{0}}} )}^{{x}_{i 0}} \times {( \frac{{e}^{{b}_{1}}}{1 + {e}^{{b}_{1}}} )}^{{x}_{i 1}} \times … {( \frac{{e}^{{b}_{k}}}{1 + {e}^{{b}_{k}}} )}^{{x}_{i k}} \qquad ( EQUATION 3 )$$

To optimize the probability of the conversion associated with the imminent click for the individual i (Pᵢ), a loss function ( [symbol] ᵢ) may be generated for the individual i based on the probability, and a gradient descent

$$( {\to }_{{∇}_{i}} )$$

may be applied (e.g., vectorized and used to compute factors with a tensor flow matrix computation) based on a time series (Tᵢ) and the loss function ( [symbol] ᵢ) to minimize the loss function ( [symbol] ᵢ) and optimize the probability. The loss function ( [symbol] ᵢ) for the individual i may be based on a following loss equation as set forth below as EQUATION 4:

$${ℒ}_{i} = {y}_{i} log ( {p}_{i} ) + ( 1 - {y}_{i} ) log ( 1 - {p}_{i} ) + λ \times \vert {b}_{i} - {b}_{init} \vert \qquad ( EQUATION 4 )$$

In aspects, and with continued reference to the above loss equation, the loss function ( [symbol] ᵢ) may be generated for the individual i, based on the probability (pᵢ) (e.g., a calculated instance of a probability (Pᵢ)) and also a regularization variable (λ). The regularization variable (λ) may be accounted for as a penalty bias of a coefficient (bᵢ) for the individual i, to prevent overfitting based on the coefficient for the individual i such as when the coefficient (bᵢ) is too large (e.g., an absolute value of coefficient (bᵢ) compared to an initial coefficient (bᵢₙᵢₜ) is large and an outlier in, for example, a small sample size of data where the penalty bias of the regularization variable (λ) can aid to correct a resulting overfitting that may result due to the too large size of the coefficient (bᵢ). Moreover, the regularization variable (λ) may be trained, such as via the machine learning model 102 or other AI model, on one or more validation training data sets 104 comprising data of a plurality of individuals as described herein. Via the machine learning model 102, parameters and weightages of the model and outputs may be continuously fine-tuned and improved for improved accuracy of the generated click price output by the AI model. As a non-limiting example, data sets of a time exceeding a time threshold may be removed from the model (e.g., data over 30 days old).

In embodiments, the gradient descent

$$( {\to }_{{∇}_{i}} ) ,$$

based on the time series (Tᵢ) and the loss function ( [symbol] ᵢ), may be based on a following gradient descent equation as set below as EQUATION 5:

$${\to }_{{∇}_{i}} = {T}_{i} \times ( {y}_{i} \times {( - \frac{1}{1 + {e}^{\vec{b}}} )}^{{\vec{x}}_{i}} + ( 1 - {y}_{i} ) \times {( \frac{- \frac{{p}_{i}}{{p}_{{i}_{e}} - 1}}{1 + {e}^{\vec{b}}} )}^{{\vec{x}}_{i}} ) \qquad ( EQUATION 5 )$$

In aspects, the time series (Tᵢ) may be trained via the machine learning model 102 or other AI model on one or more validation training data sets 104 comprising data of the plurality of individuals. The time series (Tᵢ) may be based on at least a parameter of click weighting over time of the plurality of individuals. For example, the time series may include a weightage for a training click of the one or more validation training sets 104 that diminishes with time. As a non-limiting example, a training click of 90 days ago may be assigned a lower weight than training click of 30 days ago.

In block 230, a click price may be generated on at least the probability of the conversion associated with the imminent click for the individual i and a target acquisition cost of an entity. In aspects, the entity may be an advertiser. Further, the target acquisition cost may be a predetermined value provided by the advertiser, such as via the advertiser database 110, and may be indicative of desired spend for a product (e.g., as a portion of a sale price for the product) to associate with the click price. Further, the probability of the conversion associated with the imminent click for the individual i may be further based on a pre-determined publisher parameter associated with one or more types of click traffic. As a non-limiting example, a pre-determined publisher parameter may be used to overwrite a probability based on an initial type of click traffic, such as 50% search and 50% social media. The publisher may after training change the type of click traffic to 100% search, and the publisher may dynamically change the pre-determined publisher parameter to accommodate and account for such a change (e.g., due to heuristic data such as click traffic type that cannot be modeled or accessed but rather is provided such as via being communicated, e.g., by the publisher after training has started). In additional or alternative aspects, the generated click price may be automatically validated against a reference click price by an artificial intelligence model, and output in accordance with a validation output 114, as well as and one or more alerts 116.

In aspects, the validation output 114 as well as the one or more alerts 116 based on the results of the validation may be transmitted to a user, such as to at least one of an email, a graphical user interface (GUI) of a computing device 324 of the one or more users of the system 300, a server 320, or any combination thereof. The validation output 114 (e.g., a validation has passed or failed) and the one or more alerts 116 (indicative of the passed validation or of a failed validation with optional recommendations based on the reported result) may be automatically generated based on the click price generation. The validation output 114 and/or the one or more alerts 116 may be displayed at a dashboard GUI as a centralized location of the AI based software application of the system 300 of FIG. 3, which is described in greater detail below.

FIG. 3 illustrates a computer implemented system 300 for use with the process 200 of FIG. 2. Referring to FIG. 3, a non-transitory, system 300 for implementing a computer and software-based method, such as directed by the environment 100 and the process 200, for intelligent machine learning model prediction as described herein. The system 300 comprises a communication path 302, one or more processors 304, a non-transitory memory component 306, a click price generation module 312, a factors sub-module 312A of the click price generation module 312, a storage or database 314, a machine learning module 316, a network interface hardware 318, a network 322, a server 320, and a computing device 324. The various components of the system 300 and the interaction thereof will be described in detail below.

While only one server 320 and one computing device 324 are illustrated, the system 300 can comprise multiple servers containing one or more applications and computing devices. In some embodiments, the system 300 is implemented using a wide area network (WAN) or network 322, such as an intranet or the internet. The computing device 324 may include digital systems and other devices permitting connection to and navigation of the network. It is contemplated and within the scope of this disclosure that the computing device 324 may be a personal computer, a laptop device, a smart mobile device such as a smart phone or smart pad, or the like. Other system 300 variations allowing for communication between various geographically diverse components are possible. The lines depicted in FIG. 3 indicate communication rather than physical connections between the various components.

The system 300 comprises the communication path 302. The communication path 302 may be formed from any medium that is capable of transmitting a signal such as, for example, conductive wires, conductive traces, optical waveguides, or the like, or from a combination of mediums capable of transmitting signals. The communication path 302 communicatively couples the various components of the system 300. As used herein, the term “communicatively coupled” means that coupled components are capable of exchanging data signals with one another such as, for example, electrical signals via conductive medium, electromagnetic signals via air, optical signals via optical waveguides, and the like.

The system 300 of FIG. 3 also comprises the processor 304. The processor 304 can be any device capable of executing machine readable instructions. Accordingly, the processor 304 may be a controller, an integrated circuit, a microchip, a computer, or any other computing device. The processor 304 is communicatively coupled to the other components of the system 300 by the communication path 302. Accordingly, the communication path 302 may communicatively couple any number of processors with one another, and allow the modules coupled to the communication path 302 to operate in a distributed computing environment. Specifically, each of the modules can operate as a node that may send and/or receive data.

The illustrated system 300 further comprises the memory component 306 which is coupled to the communication path 302 and communicatively coupled to the processor 304. The memory component 306 may be a non-transitory computer readable medium or non-transitory computer readable memory and may be configured as a nonvolatile computer readable medium. The memory component 306 may comprise RAM, ROM, flash memories, hard drives, or any device capable of storing machine readable instructions such that the machine readable instructions can be accessed and executed by the processor 304. The machine readable instructions may comprise logic or algorithm(s) written in any programming language such as, for example, machine language that may be directly executed by the processor 304, or assembly language, object-oriented programming (OOP), scripting languages, microcode, etc., that may be compiled or assembled into machine readable instructions and stored on the memory component 306. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Still referring to FIG. 3, as noted above, the system 300 comprises the display such as the GUI on a screen of the computing device 324 for providing visual output such as, for example, information, graphical reports, messages, or a combination thereof. The display on the screen of the computing device 324 is coupled to the communication path 302 and communicatively coupled to the processor 304. Accordingly, the communication path 302 communicatively couples the display to other modules of the system 300. The display can comprise any medium capable of transmitting an optical output such as, for example, a cathode ray tube, light emitting diodes, a liquid crystal display, a plasma display, or the like. Additionally, it is noted that the display or the computing device 324 can comprise at least one of the processor 304 and the memory component 306. While the system 300 is illustrated as a single, integrated system in FIG. 3, in other embodiments, the systems can be independent systems.

The system 300 comprises the click price generation module 312 as described above to automatically generate a click price based on at least the probability and a target acquisition cost of an entity. The factors sub-module 312A may include a plurality of factors, as described herein, that are generated in a predetermined format, for example in response to a request or automatically generated over one or more predetermined time periods. The machine learning module 316 may include an artificial intelligence component to train and provide machine learning capabilities to a neural network as described herein.

The click price generation module 312, the factors sub-module 312A, and the machine learning module 316 are coupled to the communication path 302 and communicatively coupled to the processor 304. As will be described in further detail below, the processor 304 may process the input signals received from the system modules and/or extract information from such signals.

Data stored and manipulated in the system 300 as described herein is utilized by the machine learning module 316, which is able to leverage a cloud computing-based network configuration such as the cloud to apply Machine Learning and Artificial Intelligence. This machine learning application may create models that can be applied by the system 300, to make it more efficient and intelligent in execution. As an example and not a limitation, the machine learning module 316 may include artificial intelligence components selected from the group consisting of an artificial intelligence engine, Bayesian inference engine, and a decision-making engine, and may have an adaptive learning engine further comprising a deep neural network learning engine.

The system 300 comprises the network interface hardware 318 for communicatively coupling the system 300 with a computer network such as network 322. The network interface hardware 318 is coupled to the communication path 302 such that the communication path 302 communicatively couples the network interface hardware 318 to other modules of the system 300. The network interface hardware 318 can be any device capable of transmitting and/or receiving data via a wireless network. Accordingly, the network interface hardware 318 can comprise a communication transceiver for sending and/or receiving data according to any wireless communication standard. For example, the network interface hardware 318 can comprise a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 3, data from various applications running on computing device 324 can be provided from the computing device 324 to the system 300 via the network interface hardware 318. The computing device 324 can be any device having hardware (e.g., chipsets, processors, memory, etc.) for communicatively coupling with the network interface hardware 318 and a network 322. Specifically, the computing device 324 can comprise an input device having an antenna for communicating over one or more of the wireless computer networks described above.

The network 322 can comprise any wired and/or wireless network such as, for example, wide area networks, metropolitan area networks, the internet, an intranet, satellite networks, or the like. Accordingly, the network 322 can be utilized as a wireless access point by the computing device 324 to access one or more servers (e.g., a server 320). The server 320 and any additional servers generally comprise processors, memory, and chipset for delivering resources via the network 322. Resources can include providing, for example, processing, storage, software, and information from the server 320 to the system 300 via the network 322. Additionally, it is noted that the server 320 and any additional servers can share resources with one another over the network 322 such as, for example, via the wired portion of the network, the wireless portion of the network, or combinations thereof.

In embodiments, when a machine learning model 102 is included in an environment 100, a click price may be generated using an AI process that is based on a probability of a conversion associated with an imminent click for an individual as well as a target acquisition cost, such as one retrieved from an entity database. Various factors may be selectively chosen, for example in response to a request or automatic generation over predetermined time periods, for inclusion or exclusion in a table in a predetermined format. The table of factors allows for determination of whether a respective factor exponent is set to 0 or 1 based on a particular truth determination of whether or not to include each factor, such as a factor pertaining to a homeowner status, an insured status, a credit status, or any combination thereof. In aspects, information relating to the individual for each type of factor may be retrieved from a form such as a customer lead form that an individual has filled out. Based on the truth determination, a respective factor solution based be solved for to determine the probability of the conversion associated with the imminent click for the individual.

The AI process can be leveraged to automatically generate a loss function for the individual, and also apply a gradient descent based on a time series to minimize the loss function and optimize the determined the probability. In aspects, the AI process may be further utilized to account for a regularization variable as a penalty bias of a coefficient for a given individual to prevent overfitting based on the coefficient for the individual and also train the regularization variable on one or more validation training data sets including data of a plurality of individuals. Further, the AI process may be leveraged to automatically generate and validate the click price and produce corresponding alerts. Such intelligent systems and methods as described herein aid to improve accuracy of the intelligent prediction and increase model updates in a timely fashion to save time, cost, and improve computing processes and efficiencies reducing associated network hindrances and accounting for potentially small sample sizes and heuristic data in the modeling over time.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is also noted that recitations herein of “at least one” component, element, etc., should not be used to create an inference that the alternative use of the articles “a” or “an” should be limited to a single component, element, etc.

It is noted that recitations herein of a component of the present disclosure being “configured” or “programmed” in a particular way, to embody a particular property, or to function in a particular manner, are structural recitations, as opposed to recitations of intended use.

It is noted that terms like “preferably,” “commonly,” and “typically,” when utilized herein, are not utilized to limit the scope of the claimed disclosure or to imply that certain features are critical, essential, or even important to the structure or function of the claimed disclosure. Rather, these terms are merely intended to identify particular aspects of an embodiment of the present disclosure or to emphasize alternative or additional features that may or may not be utilized in a particular embodiment of the present disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

### ASPECTS LISTING

Aspect 1. A system comprises a processor; and a memory storing computer-executable instructions that, when executed by the processor, cause the system to solve for a plurality of coefficients of a plurality of respective factors, wherein each coefficient is an exponent in an equation, and determine a factor value for each factor, wherein the factor value for each factor is between 0 and 1. The computer-executable instructions, when executed by the processor, further cause the system to: set a respective factor exponent for each factor value for each factor to 0 or 1 based on a truth determination of a factor whether to include each factor, wherein the respective factor exponent set to 0 is indicative of the truth determination of the factor being false, solve for a plurality of respective factor solutions based on each factor value for each factor set to a power of each respective factor exponent, determine a probability of a conversion associated with an imminent click for an individual i based on a multiplication of the plurality of respective factor solutions, and generate a click price based on at least the probability of the conversion associated with the imminent click for the individual i and a target acquisition cost of an entity.

Aspect 2. The system of Aspect 1, wherein the factor value (Factorₖ) for each factor (k) is based on a following factor value equation:

$${Factor}_{k} = \frac{{e}^{{b}_{k}}}{1 + {e}^{{b}_{k}}} .$$

Aspect 3. The system of Aspect 1 or Aspect 2, wherein the probability of the conversion associated with the imminent click for the individual i (Pᵢ) based on the multiplication of the plurality of respective factor solutions is based on a following probability equation:

$${P}_{i} = {( \frac{{e}^{{b}_{0}}}{1 + {e}^{{b}_{0}}} )}^{{x}_{i 0}} \times {( \frac{{e}^{{b}_{1}}}{1 + {e}^{{b}_{1}}} )}^{{x}_{i 1}} \times … {( \frac{{e}^{{b}_{k}}}{1 + {e}^{{b}_{k}}} )}^{{x}_{ik}} .$$

Aspect 4. The system of any of Aspect 1 to Aspect 3, wherein the computer-executable instructions, when executed by the processor, further cause the system to: generate a loss function ( [symbol] ᵢ) for the individual i based on the probability; and apply a gradient descent

$$( {\to }_{{∇}_{i}} )$$

based on a time series (Tᵢ) and the loss function ( [symbol] ᵢ) to minimize the loss function ( [symbol] ᵢ) and optimize the probability.

Aspect 5. The system of Aspect 4, wherein the computer-executable instructions, when executed by the processor, further cause the system to: generate the loss function ( [symbol] ᵢ) for the individual i based on the probability and a regularization variable as a penalty bias of a coefficient for the individual i to prevent overfitting based on the coefficient for the individual i.

Aspect 6. The system of Aspect 5, wherein the computer-executable instructions, when executed by the processor, further cause the system to: train, via an artificial intelligence model, the regularization variable on one or more validation training data sets comprising data of a plurality of individuals.

Aspect 7. The system of Aspect 4, wherein the computer-executable instructions, when executed by the processor, further cause the system to: train, via an artificial intelligence model, the time series on one or more validation training data sets comprising data of a plurality of individuals, wherein the time series is based on at least a parameter of click weighting over time of the plurality of individuals.

Aspect 8. The system of Aspect 7, wherein the time series comprises a weightage for a training click of the one or more validation training sets that diminishes with time.

Aspect 9. The system of any of Aspect 1 to Aspect 5, wherein the loss function ( [symbol] ᵢ) for the an individual i is based on a following loss equation: [symbol] ᵢ=yᵢ log(pᵢ)+(1−yᵢ)log(1−pᵢ)+λ×|bᵢ−bᵢₙᵢₜ|.

Aspect 10. The system of any of Aspect 1 to Aspect 5, wherein the gradient descent

$$( {\to }_{{∇}_{i}} )$$

based on a time series (Tᵢ) and the loss function ( [symbol] ᵢ) is based on a following gradient descent equation:

$${\to }_{{∇}_{i}} = {T}_{i} \times ( {y}_{i} \times {( - \frac{1}{1 + {e}^{\vec{b}}} )}^{{\vec{x}}_{i}} + ( 1 - {y}_{i} ) \times {( \frac{- \frac{{p}_{i}}{{p}_{{i}_{e}} - 1}}{1 + {e}^{\vec{b}}} )}^{{\vec{x}}_{i}} ) .$$

Aspect 11. The system of any of Aspect 1 to Aspect 10, wherein the entity is an advertiser, and the target acquisition cost is a predetermined value provided by the advertiser and is indicative of desired spend for a product associated with the click price.

Aspect 12. The system of any of Aspect 1 to Aspect 11, wherein the probability of the conversion associated with the imminent click for the individual i is further based on a pre-determined publisher parameter associated with one or more types of click traffic.

Aspect 13. The system of any of Aspect 1 to Aspect 12, wherein the plurality of factors includes a homeowner status, an insured status, a credit status, or any combination thereof.

Aspect 14. The system of any of Aspect 1 to Aspect 13, wherein for a factor of the plurality of factors: the respective factor exponent set to 0 is indicative of the truth determination of the factor being false or unknown, and the respective factor exponent set to 1 is indicative of the truth determination of the factor being true.

Aspect 15. A system comprises a processor; and a memory storing computer-executable instructions that, when executed by the processor, cause the system to solve for a plurality of coefficients of a plurality of respective factors, wherein each coefficient is an exponent in an equation. The computer-executable instructions, when executed by the processor, further cause the system to: determine a factor value for each factor, wherein the factor value for each factor is between 0 and 1, set a respective factor exponent for each factor value for each factor to 0 or 1 based on a truth determination of a factor whether to include each factor, wherein the respective factor exponent set to 0 is indicative of the truth determination of the factor being false, and solve for a plurality of respective factor solutions based on each factor value for each factor set to a power of each respective factor exponent. The computer-executable instructions, when executed by the processor, further cause the system to: determine a probability of a conversion associated with an imminent click for an individual i based on a multiplication of the plurality of respective factor solutions, and generate a click price based on at least the probability of the conversion associated with the imminent click for the individual i and a target acquisition cost of an advertiser, wherein the target acquisition cost is a predetermined value provided by the advertiser and is indicative of desired spend for a product associated with the click price. The plurality of factors include a homeowner status, an insured status, a credit status, or any combination thereof.

Aspect 16. The system of Aspect 15, wherein the computer-executable instructions, when executed by the processor, further cause the system to: generate a loss function ( [symbol] ᵢ) for the individual i based on the probability and a regularization variable as a penalty bias of a coefficient for the individual i to prevent overfitting based on the coefficient for the individual i; and apply a gradient descent

$$( {\to }_{{∇}_{i}} )$$

based on a time series (Tᵢ) and the loss function ( [symbol] ᵢ) to minimize the loss function ( [symbol] ᵢ) and optimize the probability.

Aspect 17. The system of Aspect 16, wherein the computer-executable instructions, when executed by the processor, further cause the system to train, via an artificial intelligence model, the time series and the regularization variable on one or more validation training data sets comprising data of a plurality of individuals, wherein the time series is based on at least a parameter of click weighting over time of the plurality of individuals, and wherein the time series comprises a weightage for a training click of the one or more validation training sets that diminishes with time.

Aspect 18. The system of any of Aspect 15 to Aspect 17, wherein the probability of the conversion associated with the imminent click for the individual i is further based on a pre-determined publisher parameter associated with one or more types of click traffic.

Aspect 19. The system of any of Aspect 15 to Aspect 18, wherein for a factor of the plurality of factors: the respective factor exponent set to 0 is indicative of the truth determination of the factor being false or unknown; and the respective factor exponent set to 1 is indicative of the truth determination of the factor being true.

Aspect 20. A method comprises solving, by a processor, for a plurality of coefficients of a plurality of respective factors, wherein each coefficient is an exponent in an equation, determining, by the processor, a factor value for each factor, wherein the factor value for each factor is between 0 and 1, and setting a respective factor exponent for each factor value for each factor to 0 or 1 based on a truth determination of a factor whether to include each factor. The respective factor exponent set to 0 is indicative of the truth determination of the factor being false. The method further comprises solving, by the processor, for a plurality of respective factor solutions based on each factor value for each factor set to a power of each respective factor exponent, determining a probability of a conversion associated with an imminent click for an individual i based on a multiplication of the plurality of respective factor solutions, and generating, by the processor, a click price based on at least the probability of the conversion associated with the imminent click for the individual i and a target acquisition cost of an entity.

What is claimed is:

1. A system comprising:
a processor; and
a memory storing computer-executable instructions that, when executed by the processor, cause the system to:
solve for a plurality of coefficients of a plurality of respective factors, wherein each coefficient is an exponent in an equation;
determine a factor value for each factor, wherein the factor value for each factor is between 0 and 1;
set a respective factor exponent for each factor value for each factor to 0 or 1 based on a truth determination of a factor whether to include each factor, wherein the respective factor exponent set to 0 is indicative of the truth determination of the factor being false;
solve for a plurality of respective factor solutions based on each factor value for each factor set to a power of each respective factor exponent;
determine a probability of a conversion associated with an imminent click for an individual i based on a multiplication of the plurality of respective factor solutions; and
generate a click price based on at least the probability of the conversion associated with the imminent click for the individual i and a target acquisition cost of an entity.

2. The system of claim 1, wherein the factor value (Factorₖ) for each factor (k) is based on a following factor value equation:
$${Factor}_{k} = \frac{{e}^{{b}_{k}}}{1 + {e}^{{b}_{k}}}$$

3. The system of claim 1, wherein the probability of the conversion associated with the imminent click for the individual i (Pᵢ) based on the multiplication of the plurality of respective factor solutions is based on a following probability equation:
$${P}_{i} = {( \frac{{e}^{{b}_{0}}}{1 + {e}^{{b}_{0}}} )}^{{x}_{i 0}} \times {( \frac{{e}^{{b}_{1}}}{1 + {e}^{{b}_{1}}} )}^{{x}_{i 1}} \times … {( \frac{{e}^{{b}_{k}}}{1 + {e}^{{b}_{k}}} )}^{{x}_{ik}}$$

4. The system of claim 1, wherein the computer-executable instructions, when executed by the processor, further cause the system to:
generate a loss function ( [symbol] ᵢ) for the individual i based on the probability; and
apply a gradient descent ( [symbol] ) based on a time series (Tᵢ) and the loss function ( [symbol] ᵢ) to minimize the loss function ( [symbol] ᵢ) and optimize the probability.

5. The system of claim 4, wherein the computer-executable instructions, when executed by the processor, further cause the system to:
generate the loss function ( [symbol] ᵢ) for the individual i based on the probability and a regularization variable as a penalty bias of a coefficient for the individual i to prevent overfitting based on the coefficient for the individual i.

6. The system of claim 5, wherein the computer-executable instructions, when executed by the processor, further cause the system to
train, via an artificial intelligence model, the regularization variable on one or more validation training data sets comprising data of a plurality of individuals.

7. The system of claim 4, wherein the computer-executable instructions, when executed by the processor, further cause the system to
train, via an artificial intelligence model, the time series on one or more validation training data sets comprising data of a plurality of individuals, wherein the time series is based on at least a parameter of click weighting over time of the plurality of individuals.

8. The system of claim 7, wherein the time series comprises a weightage for a training click of the one or more validation training sets that diminishes with time.

9. The system of claim 5, wherein the loss function ( [symbol] ᵢ) for the an individual i is based on a following loss equation:
$${ℒ}_{i} = {y}_{i} log ( {p}_{i} ) + ( 1 - {y}_{i} ) log ( 1 - {p}_{i} ) + λ \times \vert {b}_{i} - {b}_{init} \vert$$

10. The system of claim 5, wherein the gradient descent
$$( {\to }_{{∇}_{i}} )$$
based on a time series (Tᵢ) and the loss function ( [symbol] ᵢ) is based on a following gradient descent equation:
$${\to }_{{∇}_{i}} = {T}_{i} \times ( {y}_{i} \times {( - \frac{1}{1 + {e}^{\vec{b}}} )}^{{\vec{x}}_{i}} + ( 1 - {y}_{i} ) \times {( \frac{- \frac{{p}_{i}}{{p}_{{i}_{e}} - 1}}{1 + {e}^{\vec{b}}} )}^{{\vec{x}}_{i}} )$$

11. The system of claim 1, wherein the entity is an advertiser, and the target acquisition cost is a predetermined value provided by the advertiser and is indicative of desired spend for a product associated with the click price.

12. The system of claim 11, wherein the probability of the conversion associated with the imminent click for the individual i is further based on a pre-determined publisher parameter associated with one or more types of click traffic.

13. The system of claim 1, wherein the plurality of factors includes a homeowner status, an insured status, a credit status, or any combination thereof.

14. The system of claim 1, wherein for a factor of the plurality of factors:
the respective factor exponent set to 0 is indicative of the truth determination of the factor being false or unknown; and
the respective factor exponent set to 1 is indicative of the truth determination of the factor being true.

15. A system comprising:
a processor; and
a memory storing computer-executable instructions that, when executed by the processor, cause the system to:
solve for a plurality of coefficients of a plurality of respective factors, wherein each coefficient is an exponent in an equation;
determine a factor value for each factor, wherein the factor value for each factor is between 0 and 1;
set a respective factor exponent for each factor value for each factor to 0 or 1 based on a truth determination of a factor whether to include each factor, wherein the respective factor exponent set to 0 is indicative of the truth determination of the factor being false;
solve for a plurality of respective factor solutions based on each factor value for each factor set to a power of each respective factor exponent;
determine a probability of a conversion associated with an imminent click for an individual i based on a multiplication of the plurality of respective factor solutions; and
generate a click price based on at least the probability of the conversion associated with the imminent click for the individual i and a target acquisition cost of an advertiser, wherein the target acquisition cost is a predetermined value provided by the advertiser and is indicative of desired spend for a product associated with the click price, and the plurality of factors includes a homeowner status, an insured status, a credit status, or any combination thereof.

16. The system of claim 15, wherein the computer-executable instructions, when executed by the processor, further cause the system to:
generate a loss function ( [symbol] ᵢ) for the individual i based on the probability and a regularization variable as a penalty bias of a coefficient for the individual i to prevent overfitting based on the coefficient for the individual i; and
apply a gradient descent
$$( {\to }_{{∇}_{i}} )$$
based on a time series (Tᵢ) and the loss function ( [symbol] ᵢ) to minimize the loss function ( [symbol] ᵢ) and optimize the probability.

17. The system of claim 16, wherein the computer-executable instructions, when executed by the processor, further cause the system to
train, via an artificial intelligence model, the time series and the regularization variable on one or more validation training data sets comprising data of a plurality of individuals, wherein the time series is based on at least a parameter of click weighting over time of the plurality of individuals, and wherein the time series comprises a weightage for a training click of the one or more validation training sets that diminishes with time.

18. The system of claim 15, wherein the probability of the conversion associated with the imminent click for the individual i is further based on a pre-determined publisher parameter associated with one or more types of click traffic.

19. The system of claim 15, wherein for a factor of the plurality of factors:
the respective factor exponent set to 0 is indicative of the truth determination of the factor being false or unknown; and
the respective factor exponent set to 1 is indicative of the truth determination of the factor being true.

20. A method comprising:
solving, by a processor, for a plurality of coefficients of a plurality of respective factors, wherein each coefficient is an exponent in an equation;
determining, by the processor, a factor value for each factor, wherein the factor value for each factor is between 0 and 1;
setting a respective factor exponent for each factor value for each factor to 0 or 1 based on a truth determination of a factor whether to include each factor, wherein the respective factor exponent set to 0 is indicative of the truth determination of the factor being false;
solving, by the processor, for a plurality of respective factor solutions based on each factor value for each factor set to a power of each respective factor exponent;
determining a probability of a conversion associated with an imminent click for an individual i based on a multiplication of the plurality of respective factor solutions; and
generating, by the processor, a click price based on at least the probability of the conversion associated with the imminent click for the individual i and a target acquisition cost of an entity.
